(19) United States
(12) Patent Application Publication
(10) Pub. No.: US 2025/0012905 A1
(43) Pub. Date: Jan. 9, 2025

(54) FMCW RADAR AND LIDAR SIGNAL PROCESSING ARCHITECTURE FOR AUTONOMOUS VEHICLES

(71) Applicant: Apollo Autonomous Driving USA LLC, Sunnyvale, CA (US)

(72) Inventor: QIANG WANG, Cupertino, CA (US)

(21) Appl. No.: 18/219,506

(22) Filed: Jul. 7, 2023

(51) Int. Cl. G01S 7/4912; G01S 7/35; G01S 7/4911; G01S 13/58; G01S 13/931; G01S 17/58; G01S 17/931

(52) U.S. Cl. CPC G01S 7/4912; G01S 7/356; G01S 7/4911; G01S 13/58; G01S 13/931; G01S 17/58; G01S 17/931

(57) ABSTRACT

In one embodiment, a frequency-modulated continuous-wave (FMCW) radar-lidar system for an autonomous driving vehicle (ADV) includes one or more lidar frontends configured to generate one or more frames of lidar data. The system includes one or more radar frontends configured to generate one or more frames of radar data. The system includes a plurality of input/output (I/O) interfaces, each corresponding to one of the one or more lidar or radar frontends to receive the radar or lidar data. The system includes an edge device coupled to the plurality of input/output (I/O) interfaces, where the edge device receives the radar data or lidar data for processing to generate a set of 4D point clouds from the radar or lidar data, and the set of 4D point clouds are used to perceive a surrounding environment of the ADV.

### TECHNICAL FIELD

Embodiments of the present disclosure relate generally to operating autonomous driving vehicles. More particularly, embodiments of the disclosure relate to a frequency-modulated continuous-wave (FMCW) radar and lidar signal processing architecture for autonomous driving vehicles (ADV).

### BACKGROUND

Vehicles operating in an autonomous mode (e.g., driverless) can relieve occupants, especially the driver, from some driving-related responsibilities. When operating in an autonomous mode, the vehicle can navigate to various locations using onboard sensors, allowing the vehicle to travel with minimal human interaction or in some cases without any passengers.

Radar (radio detection and ranging) is a radiolocation system that uses radio waves to detect objects in the environment. A radar system includes a transmitter that generates electromagnetic waves in the radio or microwaves domain. Radio waves (pulsed or continuous) emitted from the transmitter reflect off objects and return to a receiver of the radar system, provides information about the objects' locations and speeds.

Lidar (light detection and ranging) is a system for determining ranges by targeting an object or a surface with a laser and measuring the time for the reflected light to return to the receiver.

### BRIEF DESCRIPTION OF THE DRAWINGS

Embodiments of the disclosure are illustrated by way of example and not limitation in the figures of the accompanying drawings in which like references indicate similar elements.

FIG. 1 is a block diagram illustrating a networked system according to one embodiment.

FIG. 2 is a block diagram illustrating an example of an autonomous driving vehicle according to one embodiment.

FIGS. 3A-3B are block diagrams illustrating an example of an autonomous driving system used with an autonomous driving vehicle according to one embodiment.

FIG. 4 is a block diagram illustrating system architecture for autonomous driving according to one embodiment.

FIGS. 5A-5B are block diagrams illustrating an example of a sensor system according to one embodiment.

FIG. 6 is a block diagram illustrating a centralized LIDAR/RADAR signal processing architecture for autonomous driving according to one embodiment.

FIG. 7A is a block diagram illustrating FMCW radar system for autonomous driving according to one embodiment.

FIG. 7B is a block diagram illustrating FMCW lidar system for autonomous driving according to one embodiment.

FIGS. 8A-8B are block diagrams illustrating FFT processing tasks according to one embodiment.

FIG. 9 is a block diagram illustrating a FMCW signal processing module according to one embodiment.

FIG. 10 is a block diagram illustrating FFT multiprocessing according to one embodiment.

FIG. 11 is a flow diagram illustrating a process to generate four-dimensional (4D) point clouds according to one embodiment.

### DETAILED DESCRIPTION

Various embodiments and aspects of the disclosure will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to some embodiments, a centralized high performance computing architecture is disclosed for processing of frequency modulated continuous wave (FMCW)-based radar and lidar signals from radar and lidar sensors. The centralized architecture lowers power consumption, lowers wiring costs, and the space needed in comparison to modular radar and lidar sensor designs.

High performance frequency modulated continuous wave (FMCW)-based Radar and Lidar shows great value for autonomous driving because they can provide a 3D scene of the surrounding environment and velocity information of detected objects in the surrounding environment. The drawbacks of FMCW-based radar and lidar are the high complexity and high costs of the FMCW receiver systems in signal processing the sensor information in comparison with pulse-Doppler radar and time-of-flight-based lidar.

Current FMCW-based radar systems are modular based designs. E.g., both sensors and signal processing engine are packed in a same sensor unit. FMCW Radar and Lidar for high resolution applications require high computing power and the modular sensor design has a high cost, and requires a high power consumption when multiple sensor units are used for autonomous driving applications.

Current ADAS systems typically integrates fewer number of and lower performance modular sensor units, compared to autonomous driving vehicles. For ADV system, the sensor performance and number of sensors required are usually higher than advanced driver assistance (ADAS) system, and a centralized high performance computing architecture can reduce power consumption, and increase cost savings in comparison to the modular sensor units.

According to a first aspect, an embodiment of the disclosure relates to a frequency-modulated continuous-wave (FMCW) radar-lidar system for an autonomous driving vehicle (ADV). The system includes one or more lidar frontends configured to transmit an incident light signal and to detect a reflected light signal, the reflected and incident light signals are used to generate one or more frames of lidar data. The system includes one or more radar frontends configured to transmit an incident electromagnetic wave signal and to detect a reflected electromagnetic wave signal, the reflected and incident electromagnetic wave signals are used to generate one or more frames of radar data. The system includes a plurality of input/output (I/O) interfaces, each corresponding to one of the one or more lidar frontends or one of the one or more radar frontends to receive the radar data or lidar data. The system includes an edge device coupled to the plurality of input/output (I/O) interfaces, where the edge device receives the radar data or lidar data for processing. The edge device includes a plurality of processing cores and a memory coupled to the processing cores, where the processing cores are configured to generate a set of 4D point clouds including a 4D point cloud of radar data and a 4D point cloud of lidar data from the radar data or lidar data, and the set of 4D point clouds are used to perceive a surrounding environment of the ADV.

In one embodiment, the set of 4D point clouds are generated by processing, by the processing cores, a plurality of fast fourier transform (FFT) kernels corresponding to the radar or lidar data concurrently, where each FFT kernel is used to perform a FFT algorithm to determine a range, a velocity, or a bearing of an obstacle.

In one embodiment, the edge device is further configured to synchronize the radar data to the lidar data by downsampling the radar data or upsampling the lidar data.

In one embodiment, the edge device is further configured to generate merged two or more 4D point clouds having at least a radar component and a lidar component using synchronized lidar and radar data.

In one embodiment, a lidar frontend includes at least an optical-electrical converter (O/E) and an analog to digital converter (ADC), where a radar frontend includes a filter and an analog to digital converter (ADC).

In one embodiment, the system further includes a field programmable gate array, where the field programmable gate array includes the plurality of I/O interfaces and a high speed serial communication bus interface, where data at the plurality of I/O interfaces are serialized and are sent to the edge device through the high speed serial communication bus interface.

In one embodiment, the field programmable gate array further includes: a plurality of data buffers corresponding to the plurality of I/O interfaces, where each of the plurality of data buffers stores N samples of data from an analog to digital converter in a first in first out manner, where N is an integer number greater than 0.

In one embodiment, the edge device is further configured to transfer the N samples of data from the plurality of data buffers at the field programmable gate array to the processing cores of the edge device via a DMA engine of the edge device.

In one embodiment, the edge device is further configured to compress a set of 4D point cloud using a compression technique.

In one embodiment, a data format for a 4D point cloud includes a front-end module identifier specifying an identifier of a frontend device, a time stamp, and cloud data specifying velocity, range, and angular bearings of a surrounding of an ADV.

According to a second aspect, an embodiment discloses a method. The method includes receiving, from a lidar frontend, one or more frames of lidar data. The method includes receiving, from a radar frontend, one or more frames of radar data. The method includes initializing and launching a plurality of fast fourier transform (FFT) kernels, where each FFT kernel is executed by one of a plurality of processing cores of an edge device to process a frame of lidar or radar data. The method includes determining range and velocity information for each frame of lidar or radar data. The method includes generating a set of 4D point clouds including a 4D point cloud of radar data and a 4D point cloud of lidar data from the determined range and velocity information. The method includes transmitting the set of 4D point clouds to an autonomous driving system (ADS) of an autonomous driving vehicle (ADV), where the set of 4D point clouds are used to perceive a surrounding environment of the ADV.

According to a third aspect, an embodiment discloses an autonomous driving vehicle (ADV). The ADV includes an autonomous driving system and a frequency-modulated continuous-wave (FMCW) radar-lidar system coupled to the autonomous driving system to provide a set of 4D point clouds to the autonomous driving system. The FMCW radar-lidar system includes one or more lidar frontends configured to transmit an incident light signal and to detect a reflected light signal, the reflected and incident light signals are used to generate one or more frames of lidar data. The system includes one or more radar frontends configured to transmit an incident electromagnetic wave signal and to detect a reflected electromagnetic wave signal, the reflected and incident electromagnetic wave signals are used to generate one or more frames of radar data. The system includes a plurality of input/output (I/O) interfaces, each corresponding to one of the one or more lidar frontends or one of the one or more radar frontends to receive the radar data or lidar data. The system includes an edge device coupled to the plurality of input/output (I/O) interfaces, where the edge device receives the radar data or lidar data for processing. The edge device includes a plurality of processing cores and a memory coupled to the processing cores, where the processing cores are configured to generate a set of 4D point clouds including a 4D point cloud of radar data and a 4D point cloud of lidar data from the radar data or lidar data, and the set of 4D point clouds are used to perceive a surrounding environment of the ADV.

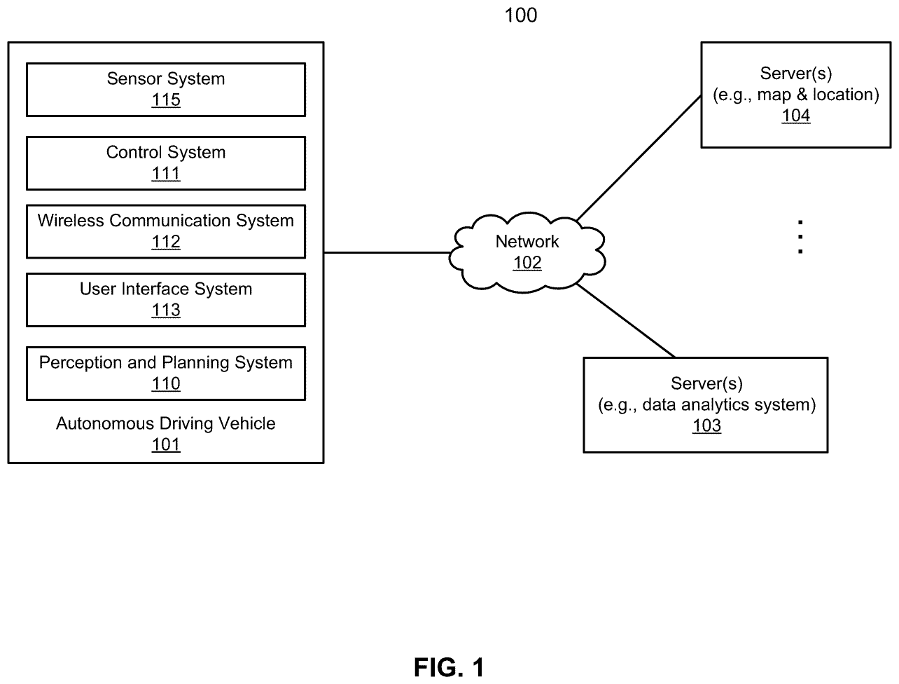

FIG. 1 is a block diagram illustrating an autonomous driving network configuration according to one embodiment of the disclosure. Referring to FIG. 1, network configuration 100 includes autonomous driving vehicle (ADV) 101 that may be communicatively coupled to one or more servers 103-104 over a network 102. Although there is one ADV shown, multiple ADVs can be coupled to each other and/or coupled to servers 103-104 over network 102. Network 102 may be any type of networks such as a local area network (LAN), a wide area network (WAN) such as the Internet, a cellular network, a satellite network, or a combination thereof, wired or wireless. Server(s) 103-104 may be any kind of servers or a cluster of servers, such as Web or cloud servers, application servers, backend servers, or a combination thereof. Servers 103-104 may be data analytics servers, content servers, traffic information servers, map and point of interest (MPOI) servers, or location servers, etc.

An ADV refers to a vehicle that can be configured to in an autonomous mode in which the vehicle navigates through an environment with little or no input from a driver. Such an ADV can include a sensor system having one or more sensors that are configured to detect information about the environment in which the vehicle operates. The vehicle and its associated controller(s) use the detected information to navigate through the environment. ADV 101 can operate in a manual mode, a full autonomous mode, or a partial autonomous mode.

In one embodiment, ADV 101 includes, but is not limited to, autonomous driving system (ADS) 110, vehicle control system 111, wireless communication system 112, user interface system 113, and sensor system 115. ADV 101 may further include certain common components included in ordinary vehicles, such as, an engine, wheels, steering wheel, transmission, etc., which may be controlled by vehicle control system 111 and/or ADS 110 using a variety of communication signals and/or commands, such as, for example, acceleration signals or commands, deceleration signals or commands, steering signals or commands, braking signals or commands, etc.

Components 110-115 may be communicatively coupled to each other via an interconnect, a bus, a network, or a combination thereof. For example, components 110-115 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

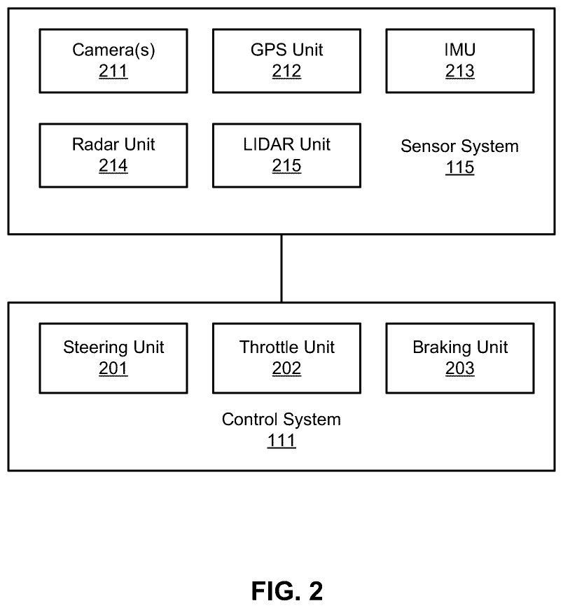

Referring now to FIG. 2, in one embodiment, sensor system 115 includes, but it is not limited to, one or more cameras 211, global positioning system (GPS) unit 212, inertial measurement unit (IMU) 213, radar unit 214, and a light detection and range (LIDAR) unit 215. GPS system 212 may include a transceiver operable to provide information regarding the position of the ADV. IMU unit 213 may sense position and orientation changes of the ADV based on inertial acceleration. Radar unit 214 may represent a system that utilizes radio signals to sense objects within the local environment of the ADV. In some embodiments, in addition to sensing objects, radar unit 214 may additionally sense the speed and/or heading of the objects. LIDAR unit 215 may sense objects in the environment in which the ADV is located using lasers. LIDAR unit 215 could include one or more laser sources, a laser scanner, and one or more detectors, among other system components. Cameras 211 may include one or more devices to capture images of the environment surrounding the ADV. Cameras 211 may be still cameras and/or video cameras. A camera may be mechanically movable, for example, by mounting the camera on a rotating and/or tilting a platform.

Sensor system 115 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the ADV. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, vehicle control system 111 includes, but is not limited to, steering unit 201, throttle unit 202 (also referred to as an acceleration unit), and braking unit 203. Steering unit 201 is to adjust the direction or heading of the vehicle. Throttle unit 202 is to control the speed of the motor or engine that in turn controls the speed and acceleration of the vehicle. Braking unit 203 is to decelerate the vehicle by providing friction to slow the wheels or tires of the vehicle. Note that the components as shown in FIG. 2 may be implemented in hardware, software, or a combination thereof.

Referring back to FIG. 1, wireless communication system 112 is to allow communication between ADV 101 and external systems, such as devices, sensors, other vehicles, etc. For example, wireless communication system 112 can wirelessly communicate with one or more devices directly or via a communication network, such as servers 103-104 over network 102. Wireless communication system 112 can use any cellular communication network or a wireless local area network (WLAN), e.g., using WiFi to communicate with another component or system. Wireless communication system 112 could communicate directly with a device (e.g., a mobile device of a passenger, a display device, a speaker within vehicle 101), for example, using an infrared link, Bluetooth, etc. User interface system 113 may be part of peripheral devices implemented within vehicle 101 including, for example, a keyboard, a touch screen display device, a microphone, and a speaker, etc.

Some or all of the functions of ADV 101 may be controlled or managed by ADS 110, especially when operating in an autonomous driving mode. ADS 110 includes the necessary hardware (e.g., processor(s), memory, storage) and software (e.g., operating system, planning and routing programs) to receive information from sensor system 115, control system 111, wireless communication system 112, and/or user interface system 113, process the received information, plan a route or path from a starting point to a destination point, and then drive vehicle 101 based on the planning and control information. Alternatively, ADS 110 may be integrated with vehicle control system 111.

For example, a user as a passenger may specify a starting location and a destination of a trip, for example, via a user interface. ADS 110 obtains the trip related data. For example, ADS 110 may obtain location and route data from an MPOI server, which may be a part of servers 103-104. The location server provides location services and the MPOI server provides map services and the POIs of certain locations. Alternatively, such location and MPOI information may be cached locally in a persistent storage device of ADS 110.

While ADV 101 is moving along the route, ADS 110 may also obtain real-time traffic information from a traffic information system or server (TIS). Note that servers 103-104 may be operated by a third party entity. Alternatively, the functionalities of servers 103-104 may be integrated with ADS 110. Based on the real-time traffic information, MPOI information, and location information, as well as real-time local environment data detected or sensed by sensor system 115 (e.g., obstacles, objects, nearby vehicles), ADS 110 can plan an optimal route and drive vehicle 101, for example, via control system 111, according to the planned route to reach the specified destination safely and efficiently.

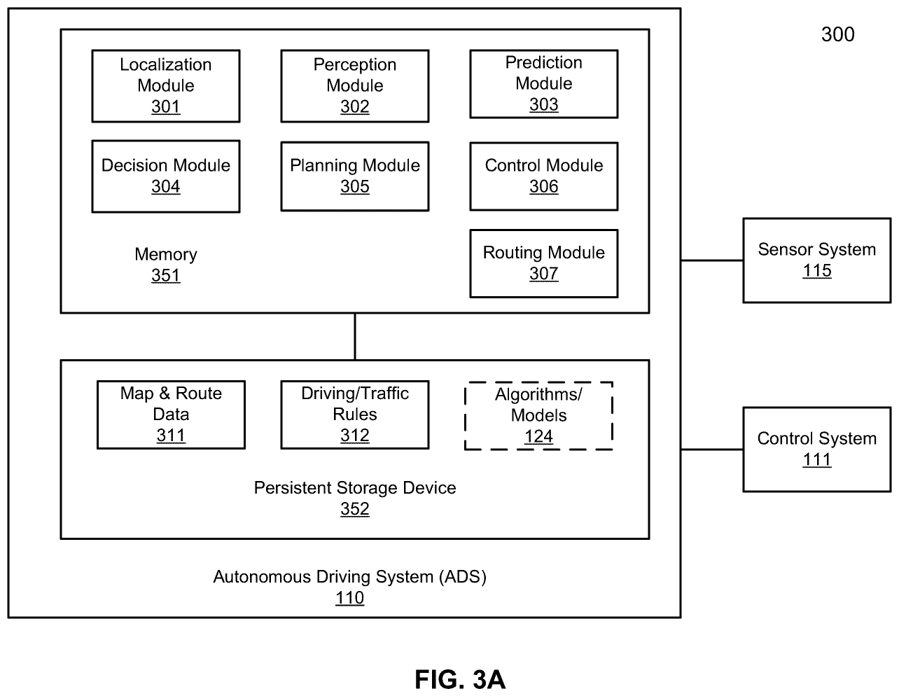

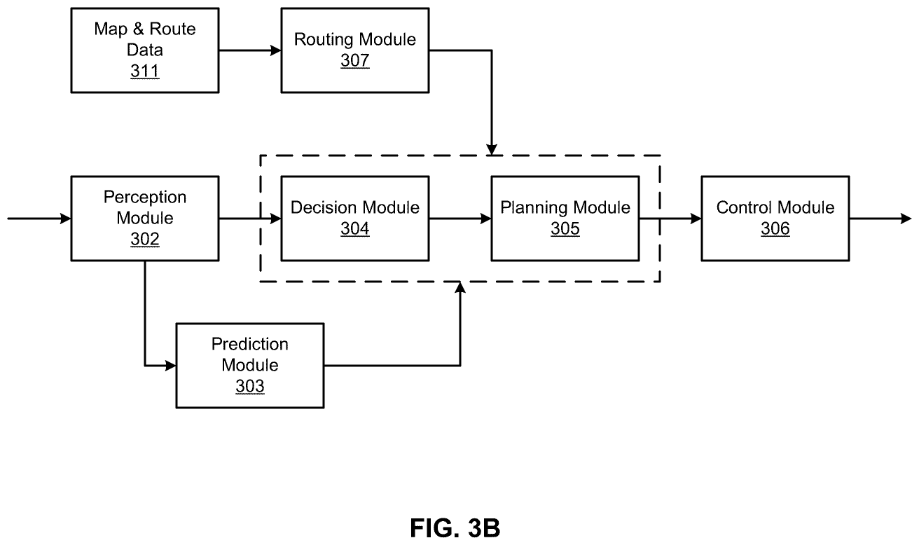

FIGS. 3A and 3B are block diagrams illustrating an example of an autonomous driving system used with an ADV according to one embodiment. System 300 may be implemented as a part of ADV 101 of FIG. 1 including, but is not limited to, ADS 110, control system 111, and sensor system 115. Referring to FIGS. 3A-3B, ADS 110 includes, but is not limited to, localization module 301, perception module 302, prediction module 303, decision module 304, planning module 305, control module 306, and routing module 307.

Some or all of modules 301-307 may be implemented in software, hardware, or a combination thereof. For example, these modules may be installed in persistent storage device 352, loaded into memory 351, and executed by one or more processors (not shown). Note that some or all of these modules may be communicatively coupled to or integrated with some or all modules of vehicle control system 111 of FIG. 2. Some of modules 301-307 may be integrated together as an integrated module.

Localization module 301 determines a current location of ADV 101 (e.g., leveraging GPS unit 212) and manages any data related to a trip or route of a user. Localization module 301 (also referred to as a map and route module) manages any data related to a trip or route of a user. A user may log in and specify a starting location and a destination of a trip, for example, via a user interface. Localization module 301 communicates with other components of ADV 101, such as map and route data 311, to obtain the trip related data. For example, localization module 301 may obtain location and route data from a location server and a map and POI (MPOI) server. A location server provides location services and an MPOI server provides map services and the POIs of certain locations, which may be cached as part of map and route data 311. While ADV 101 is moving along the route, localization module 301 may also obtain real-time traffic information from a traffic information system or server.

Based on the sensor data provided by sensor system 115 and localization information obtained by localization module 301, a perception of the surrounding environment is determined by perception module 302. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 302 may include a computer vision system or functionalities of a computer vision system to process and analyze images captured by one or more cameras in order to identify objects and/or features in the environment of the ADV. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 302 can also detect objects based on other sensors data provided by other sensors such as a radar and/or LIDAR.

For each of the objects, prediction module 303 predicts what the object will behave under the circumstances. The prediction is performed based on the perception data perceiving the driving environment at the point in time in view of a set of map/route information 311 and traffic rules 312. For example, if the object is a vehicle at an opposing direction and the current driving environment includes an intersection, prediction module 303 will predict whether the vehicle will likely move straight forward or make a turn. If the perception data indicates that the intersection has no traffic light, prediction module 303 may predict that the vehicle may have to fully stop prior to enter the intersection. If the perception data indicates that the vehicle is currently at a left-turn only lane or a right-turn only lane, prediction module 303 may predict that the vehicle will more likely make a left turn or right turn respectively.

For each of the objects, decision module 304 makes a decision regarding how to handle the object. For example, for a particular object (e.g., another vehicle in a crossing route) as well as its metadata describing the object (e.g., a speed, direction, turning angle), decision module 304 decides how to encounter the object (e.g., overtake, yield, stop, pass). Decision module 304 may make such decisions according to a set of rules such as traffic rules or driving rules 312, which may be stored in persistent storage device 352.

Routing module 307 is configured to provide one or more routes or paths from a starting point to a destination point. For a given trip from a start location to a destination location, for example, received from a user, routing module 307 obtains route and map information 311 and determines all possible routes or paths from the starting location to reach the destination location. Routing module 307 may generate a reference line in a form of a topographic map for each of the routes it determines from the starting location to reach the destination location. A reference line refers to an ideal route or path without any interference from others such as other vehicles, obstacles, or traffic condition. That is, if there is no other vehicle, pedestrians, or obstacles on the road, an ADV should exactly or closely follows the reference line. The topographic maps are then provided to decision module 304 and/or planning module 305. Decision module 304 and/or planning module 305 examine all of the possible routes to select and modify one of the most optimal routes in view of other data provided by other modules such as traffic conditions from localization module 301, driving environment perceived by perception module 302, and traffic condition predicted by prediction module 303. The actual path or route for controlling the ADV may be close to or different from the reference line provided by routing module 307 dependent upon the specific driving environment at the point in time.

Based on a decision for each of the objects perceived, planning module 305 plans a path or route for the ADV, as well as driving parameters (e.g., distance, speed, and/or turning angle), using a reference line provided by routing module 307 as a basis. That is, for a given object, decision module 304 decides what to do with the object, while planning module 305 determines how to do it. For example, for a given object, decision module 304 may decide to pass the object, while planning module 305 may determine whether to pass on the left side or right side of the object. Planning and control data is generated by planning module 305 including information describing how vehicle 101 would move in a next moving cycle (e.g., next route/path segment). For example, the planning and control data may instruct vehicle 101 to move 10 meters at a speed of 30 miles per hour (mph), then change to a right lane at the speed of 25 mph.

Based on the planning and control data, control module 306 controls and drives the ADV, by sending proper commands or signals to vehicle control system 111, according to a route or path defined by the planning and control data. The planning and control data include sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 305 plans a next route segment or path segment, for example, including a target position and the time required for the ADV to reach the target position. Alternatively, planning module 305 may further specify the specific speed, direction, and/or steering angle, etc. In one embodiment, planning module 305 plans a route segment or path segment for the next predetermined period of time such as 5 seconds. For each planning cycle, planning module 305 plans a target position for the current cycle (e.g., next 5 seconds) based on a target position planned in a previous cycle. Control module 306 then generates one or more control commands (e.g., throttle, brake, steering control commands) based on the planning and control data of the current cycle.

Note that decision module 304 and planning module 305 may be integrated as an integrated module. Decision module 304/planning module 305 may include a navigation system or functionalities of a navigation system to determine a driving path for the ADV. For example, the navigation system may determine a series of speeds and directional headings to affect movement of the ADV along a path that substantially avoids perceived obstacles while generally advancing the ADV along a roadway-based path leading to an ultimate destination. The destination may be set according to user inputs via user interface system 113. The navigation system may update the driving path dynamically while the ADV is in operation. The navigation system can incorporate data from a GPS system and one or more maps so as to determine the driving path for the ADV.

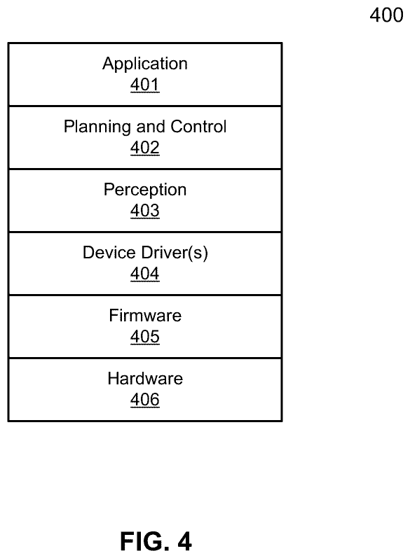

FIG. 4 is a block diagram illustrating system architecture for autonomous driving according to one embodiment. System architecture 400 may represent system architecture of an autonomous driving system as shown in FIGS. 3A and 3B. Referring to FIG. 4, system architecture 400 includes, but it is not limited to, application layer 401, planning and control (PNC) layer 402, perception layer 403, driver layer 404, firmware layer 405, and hardware layer 406. Application layer 401 may include user interface or configuration application that interacts with users or passengers of an autonomous driving vehicle, such as, for example, functionalities associated with user interface system 113. PNC layer 402 may include functionalities of at least planning module 305 and control module 306. Perception layer 403 may include functionalities of at least perception module 302. In one embodiment, there is an additional layer including the functionalities of prediction module 303 and/or decision module 304. Alternatively, such functionalities may be included in PNC layer 402 and/or perception layer 403. System architecture 400 further includes driver layer 404, firmware layer 405, and hardware layer 406. Firmware layer 405 may represent at least the functionality of sensor system 115, which may be implemented in a form of a field programmable gate array (FPGA). Hardware layer 406 may represent the hardware of the autonomous driving vehicle such as control system 111. Layers 401-403 can communicate with firmware layer 405 and hardware layer 406 via device driver layer 404.

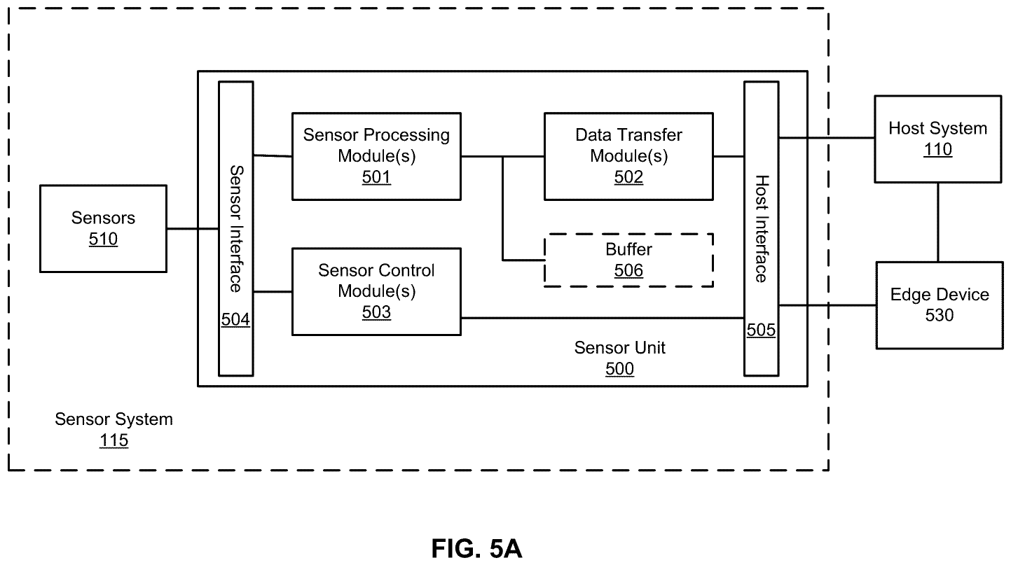

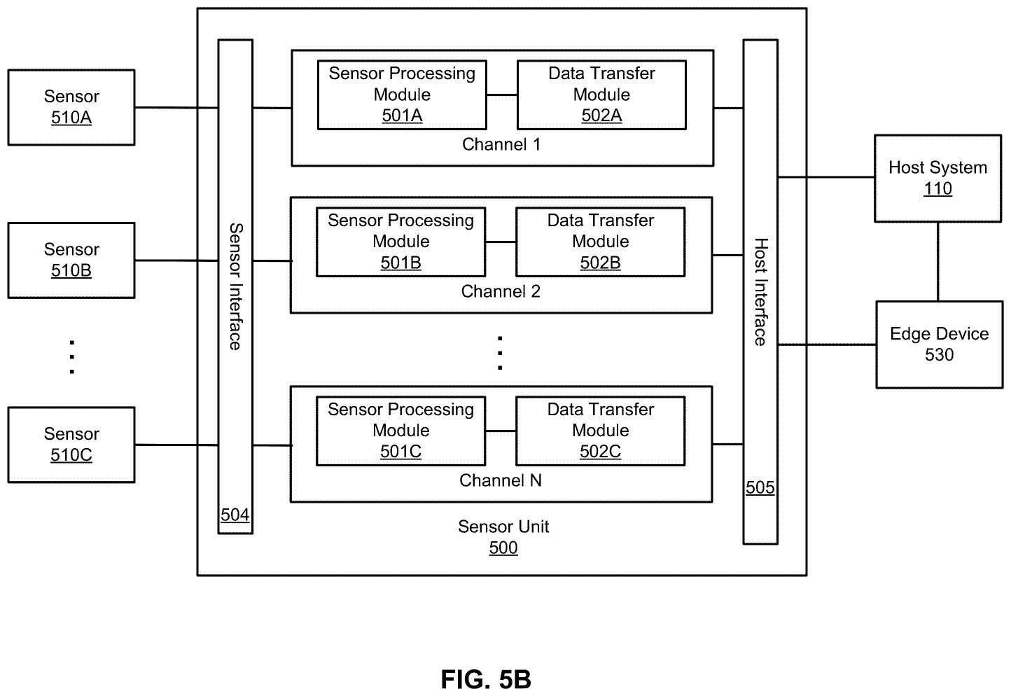

FIG. 5A is a block diagram illustrating an example of a sensor system according to one embodiment of the invention. Referring to FIG. 5A, sensor system 115 includes a number of sensors 510 and a sensor unit 500 coupled to host system 110. Host system 110 represents a planning and control system as described above, which may include at least some of the modules as shown in FIGS. 3A and 3B. Sensor unit 500 may be implemented in a form of an FPGA device or an ASIC (application specific integrated circuit) device. In one embodiment, sensor unit 500 includes, amongst others, one or more sensor data processing modules 501 (also simply referred to as sensor processing modules), data transfer modules 502, and sensor control modules or logic 503. Modules 501-503 can communicate with sensors 510 via a sensor interface 504 and communicate with host system 110 via interface 505. Optionally, an internal or external buffer 506 may be utilized for buffering the data for processing. In some embodiments, Modules 501-503 can communicate with sensors 510 via a sensor interface 504 and communicate with edge device 530 via interface 505. Edge device 530 can communicate with host system 110.

In one embodiment, for the receiving path or upstream direction, sensor processing module 501 is configured to receive sensor data from a sensor via sensor interface 504 and process the sensor data (e.g., format conversion, error checking), which may be temporarily stored in buffer 506. Data transfer module 502 is configured to transfer the processed data to host system 110 using a communication protocol compatible with interface 505. In one embodiment, data transfer module 502 is configured to transfer the processed data to edge device 530 using a communication protocol compatible with interface 505. Sensor data is further processed by edge device and the processed data are transferred to host system 110.

In one embodiment, for the transmitting path or downstream direction, data transfer module 502 is configured to receive data or commands from host system 110. The data is then processed by sensor processing module 501 to a format that is compatible with the corresponding sensor. The processed data is then transmitted to the sensor.

In one embodiment, sensor control module or logic 503 is configured to control certain operations of sensors 510, such as, for example, timing of activation of capturing sensor data, in response to commands received from host system (e.g., perception module 302) via interface 505. Host system 110 can configure sensors 510 to capture sensor data in a collaborative and/or synchronized manner, such that the sensor data can be utilized to perceive a driving environment surrounding the vehicle at any point in time.

Sensor interface 504 can include one or more of Ethernet, USB (universal serial bus), LTE (long term evolution) or cellular, WiFi, GPS, camera, CAN, serial (e.g., universal asynchronous receiver transmitter or UART), SIM (subscriber identification module) card, and other general purpose input/output (GPIO) interfaces. Interface 505 may be any high speed or high bandwidth interface such as PCIe (peripheral component interconnect or PCI express) interface. Sensors 510 can include a variety of sensors that are utilized in an autonomous driving vehicle, such as, for example, a camera, a LIDAR device, a RADAR device, a GPS receiver, an IMU, an ultrasonic sensor, a GNSS (global navigation satellite system) receiver, an LTE or cellular SIM card, vehicle sensors (e.g., throttle, brake, steering sensors), and system sensors (e.g., temperature, humidity, pressure sensors), etc.

For example, a camera can be coupled via an Ethernet or a GPIO interface. A GPS sensor can be coupled via a USB or a specific GPS interface. Vehicle sensors can be coupled via a CAN interface. A RADAR sensor or an ultrasonic sensor can be coupled via a GPIO interface. A LIDAR device can be coupled via an Ethernet interface. An external SIM module can be coupled via an LTE interface. Similarly, an internal SIM module can be inserted onto a SIM socket of sensor unit 500. The serial interface such as UART can be coupled with a console system for debug purposes.

Note that sensors 510 can be any kind of sensors and provided by various vendors or suppliers. Sensor processing module 501 is configured to handle different types of sensors and their respective data formats and communication protocols. According to one embodiment, each of sensors 510 is associated with a specific channel for processing sensor data and transferring the processed sensor data between host system 110 and the corresponding sensor. Each channel includes a specific sensor processing module and a specific data transfer module that have been configured or programmed to handle the corresponding sensor data and protocol, as shown in FIG. 5B.

Referring now to FIG. 5B, sensor processing modules 501A-501C are specifically configured to process sensor data obtained from sensors 510A-510C respectively. Note that sensors 510A-510C may be the same or different types of sensors. Sensor processing modules 501A-501C can be configured (e.g., software configurable) to handle different sensor processes for different types of sensors. For example, if sensor 510A is a camera, processing module 501A can be figured to handle pixel processing operations on the specific pixel data representing an image captured by camera 510A. Similarly, if sensor 510A is a LIDAR device, processing module 501A is configured to process LIDAR data specifically. That is, according to one embodiment, dependent upon the specific type of a particular sensor, its corresponding processing module can be configured to process the corresponding sensor data using a specific process or method corresponding to the type of sensor data.

Similarly, data transfer modules 502A-502C can be configured to operate in different modes, as different kinds of sensor data may be in different size or sensitivities that require different speed or timing requirement. According to one embodiment, each of data transfer modules 502A-502C can be configured to operate in one of a low latency mode, a high bandwidth mode, and a memory mode (also referred to as a fixed memory mode).

When operating in a low latency mode, according to one embodiment, a data transfer module (e.g., data transfer module 502) is configured to send the sensor data received from a sensor to the host system as soon as possible without or with minimum delay. Some of sensor data are very sensitive in terms of timing that need to be processed as soon as possible. Examples of such sensor data include vehicle status such as vehicle speed, acceleration, steering angle, etc.

When operating in a high bandwidth mode, according to one embodiment, a data transfer module (e.g., data transfer module 502) is configured to accumulate the sensor data received from a sensor up to a predetermined amount, but is still within the bandwidth the connection between the data transfer module and the host system 110. The accumulated sensor data is then transferred to the host system 110 in a batch that maximum the bandwidth of the connection between the data transfer module and host system 110. Typically, the high bandwidth mode is utilized for a sensor that produces a large amount of sensor data. Examples of such sensor data include camera pixel data.

When operating in a memory mode, according to one embodiment, a data transfer module is configured to write the sensor data received from a sensor directly to a memory location of a mapped memory of host system 110, similar to a shared memory page. Examples of the sensor data to be transferred using memory mode include system status data such as temperature, fans speed, etc.

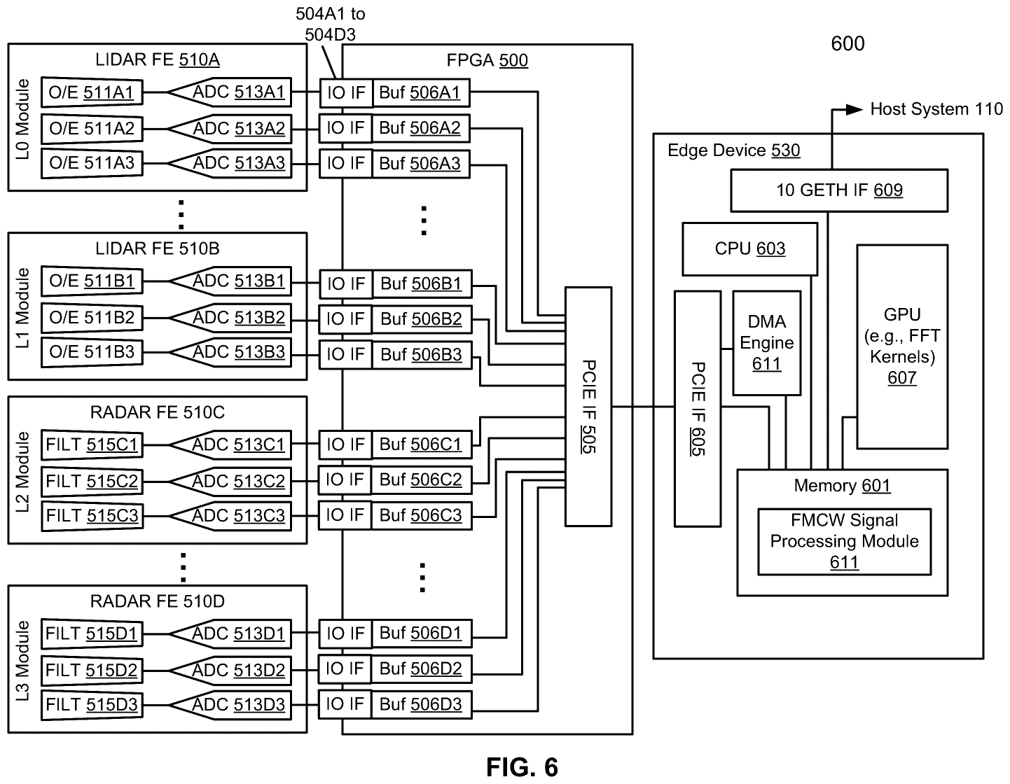

FIG. 6 is a block diagram illustrating a centralized LIDAR/RADAR signal processing architecture 600 for autonomous driving according to one embodiment.

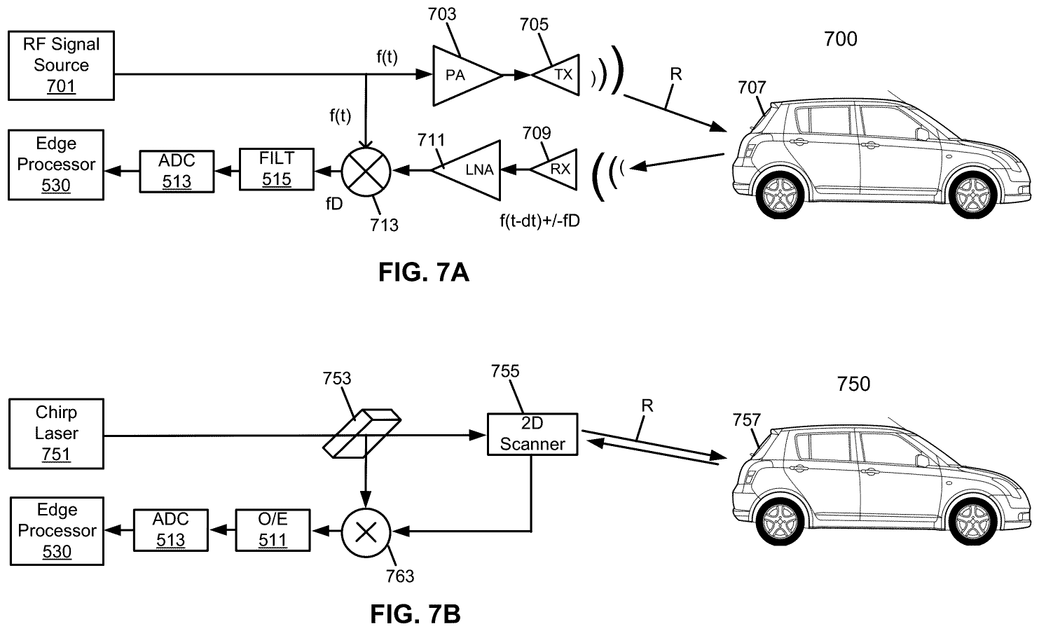

Architecture 600 can represent sensor system 115 of FIG. 5A. Referring to FIG. 6, architecture 600 can include one or more lidar frontends 510A-510B, one or more radar frontends (FE) 510C-510D, an FPGA 500, and an edge device 530. Lidar and radar frontends (FE) 510A-510D can be disposed in one or more sensor modules. Lidar FEs 510A-510B can include optical-electrical converters (O/E) 511A1-511A3, 511B1-511B3 and analog-to-digital converters (ADC) 513A1-513A3, 513B1-513B3. O/E 511A1-511A3, 511B1-511B3 can convert an optical signal to an electrical domain, or vice versa. Electrical signals output by the O/E can be digitized using the analog-to-digital converter (ADC). In some embodiments, Lidar FE can include other components such as: a laser source, a modulator, beam splitter, mixer, photodetector, and a control interface. The laser source can emit coherent light pulses in the infrared (IR) spectrum, such as 905 nm to 1550 nm. The laser source can provide the light source for the LiDAR sensor. The modulator, such as an electro-optic modulator (EOM), can control the laser beam's intensity or phase modulation to achieve frequency modulation required for FMCW operation. The splitter can split the laser beam into two paths: the transmitted beam and the local oscillator/reference beam to allow for the measurement of the frequency difference between the transmitted and received signals. The mixer can combine the received optical signal with the local oscillator/reference beam. Photodetector can detect the reflected light. The control interface to control the laser modulation, or a two-dimensional scanner at the lidar FE, as further illustrated in FIG. 7B.

Radar FEs 510C-510D can include filters 515C1-515C3, 515D1-515D3 and ADCs 513C1-513C3, 513D1-513D3. Filters 515C1-515C3, 515D1-515D3 can filter out useful band of signals by mixing received radio frequency (RF) signals with a local oscillator (LO) signal. The filtered RF signals can be digitized by analog-to-digital converter (ADC) 513C1-513C3, 513D1-513D3. In some embodiments, Radar FEs can include other components, such as a transmitter, antenna array, a mixer, and a local oscillator as further shown in FIG. 7A. The transmitter can generate a continuous wave signal with a linearly increasing or decreasing frequency sweep. The transmitter can include of a voltage-controlled oscillator (VCO) and a frequency modulator for the RF signal generation. The antenna arrays can transmit and receive RF signals. The local oscillator (LO) can generate a stable frequency signal that is mixed with the received signal at a mixer. The resulting IF signal can contain a beat frequency, which carries information about the range and velocity of a target obstacle.

In some embodiments, the ADCs for the Lidar FE and the Radar FE can be a same ADC unit but with different sampling rates (˜100 MHz to ˜10 MHz), dynamic ranges, resolutions, etc. For the laser and RF sources, a transmitted optical (laser) signal and a transmitted RF signal can have different chirp period and a sample size from the ADC can be different. Here, a chirp is a signal in which the frequency increases (up-chirp) or decreases (down-chirp) with time. A chirp laser can be used to generate a chirp optical signal for the Lidar FE. A RF signal generator can be used to generate a pulsed FMCW chirp signal for the Radar FE.

In some embodiment, the signal processing flow from the lidar/radar frontends to edge device 530 are similar for both lidar and radar. For example, regardless of Lidar or Radar, N samples of ADC data arrives at I/O interface 504A1-504D3 from a frontend is buffered in a first-in-first-out (FIFO) manner at buffers 506A1-506D3. The buffered data then waits for a readout by edge device 530. In one embodiment, the ADC interfacing, data buffering and peripheral component interconnect express (PCIE) endpoint for transfer data to edge device 530 can be performed at FPGA 500 as an FPGA can provide flexible high speed input/output and fast multiple instance of data buffering. Although implemented by an FPGA, other types of devices such as a complex programmable logic device (CPLD), system on a chip (SoC), or application-specific integrated circuit (ASIC) can interface with the ADCs.

Referring to FIG. 6, edge device 530 can include high bandwidth memory 601, a central processing unit (CPU) 603, a PCIE interface (IF) 605, SoC-based graphical processing units (GPU) 607 with multiple processing cores, an ethernet interface 609, and a dynamic memory access (DMA) engine 611. CPU 603 can execute instruction sets and to initiate DMA access for DMA engine 611 to read data samples from FPGA 500. PCIE IF 605 can interface with PCIE IF 505 of FPGA 500. Memory 601 can temporarily store lidar/radar data. GPU 607 can include multiple cores and each core can initiate and execute a FFT kernel to perform FFT algorithms on the lidar/radar data. Ethernet interface 609 can interface with host system 110 and to communicate processed lidar/radar data (e.g., 4D point clouds) to host system 110.

FIG. 7A is a block diagram illustrating FMCW radar system 700 for autonomous driving according to one embodiment. Radar (radio detection and ranging) uses radio waves to detect objects in the environment. Reflections of the radio waves can be used to determine the distance (or range), angular position (or bearing) and velocity of the detect objects.

Referring to FIG. 7A, for example, radar system 700 can include an RF signal source 701, a power amplifier 703, a transmitter 705, a receiver 709, a lower noise amplifier 711, a mixer 713, a filter 515, an analog-to-digital converter 513, and an edge processor (e.g., edge device) 530.

The RF signal source 701 can generate a frequency modulated continuous wave (FMCW) signal. A FMCW signal has a stable frequency continuous wave that continuously varies up and down in frequency over a fixed period of time by a modulating signal. That is, the characteristics of FMCW allows a range and a velocity to be measured using the difference in the frequency/phase of the detected signal to the source reference signal, as further described below.

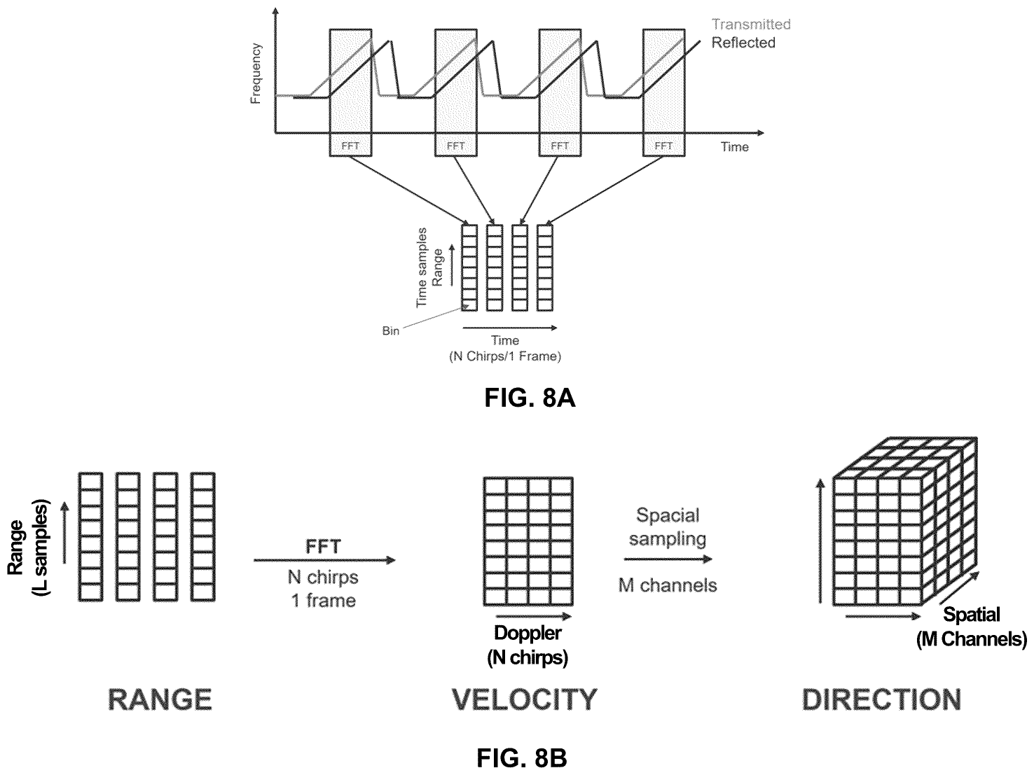

Power amplifier 703 can amplify a generated RF signal. Transmitter 705 can emit the RF signal in a certain direction, e.g., at target object 707. Receiver 709 can detect an RF signal (echo) reflected off target object 707. LNA 711 can amplifier the received signal. Mixer 713 can mix the received RF signal and the generated RF (e.g., reference) signal. Filter 515 can low pass filter the mixed signal to obtain the mixed lower frequency signal of interests. ADC 513 can digitize the signal and output the digitized signal to edge device 530 for FFT processing. Here, if the change in frequency of the reference signal is linear over a wide range, then the radar range can be determined by a frequency comparison of the FFT output (applying FFT for the vertical samples for the range, as shown in FIG. 8B). E.g., the frequency difference Δf (the frequency of the mixed signal) is proportional to the distance R for each period of the signal or “chirp”, and can be calculated by the formula:

$$R = \frac{c \vert Δ t \vert}{2} = \frac{c \vert Δ f \vert}{2 ( \frac{df}{dt} )} ,$$

where c is speed of light, Δf is the frequency difference between the reference and the received signals, ^{df}/_{dt} is the steepness of the frequency variation, e.g., slope of the example sawtooth (chirp) signal in FIG. 8A.

If the signal is monitored over a time frame, e.g., 4 chirps (each sawtooth edge representing a chirp) as shown in FIG. 8A, a phase change can be detected for the target object moving towards or away from the radar, due to the Doppler effect. This phase change can be used to determine the velocity of the target. For example, velocity can be calculated by applying a doppler-FFT algorithm (applying FFT horizontally along the chirps of FIG. 8B) to the lidar/radar data frames. The change in phases (or angular velocity ω) among the chirps can be used to calculate velocity using the formula:

$$v = \frac{λω}{4 π {T}_{c}}$$

where v is velocity, λ is the wavelength, T_{c} is the chirp period, and ω is the angular velocity. Here, once all the chirps in a frame have been acquired, saved, and processed, a Doppler-FFT algorithm can be performed on the frame to obtain information about the velocity of the target object. This evaluation can be performed once per frame.

Finally, if different channels are considered, using spatially distributed antennas, a direction of arrival of the signal can be established, to obtain the spatial position (e.g., bearing information) of the target object.

For example, as shown in FIG. 8B, each radar sample that is applied the FFT algorithm can be referred to as a bin. Here, L=8 bins or FFT samples are collected for range detection, N=4 chirps are collected over time to detect velocity, and M=4 channels are collected by spatially distributed antennas to detect the spatial position of the target object. In one embodiment, a frame of radar data can include a radar data cube over L samples, N chirps, and M channels, where L, M, and N are positive integer numbers greater than 0. In another embodiment, a frame of radar data can refer to L samples and N chirps over a single channel in the radar data cube, e.g., a slice of the data cube.

Thus, the graphical representation of the FFT data can be a radar data cube and a 4D detection (range, azimuth and elevation direction, and velocity) of target objects can be determined using the radar data cube. In one embodiment, the radar data cube can be used to generate a 4D point cloud (3D point cloud with an additional dimension for velocity information) for a surrounding environment of an ADV using multiple FMCW radar sensors. The 4D point cloud data can include information such as an identifier (ID) of the front-end identifying the lidar or radar frontend device, a time stamp, and cloud data specifying velocity (velocity), range (z-axis), and angular bearings (x-axis, y-axis) of a surrounding of an ADV. Here, the radar data cube is a three-dimensional graphic depiction of the FFT space-time processing of the stored radar data that summarizes the FFT processing required to obtain the range, velocity and bearing information of detected objects. Note that the data cube of FIG. 8B can represent both a lidar data cube or a radar data cube.

FIG. 7B is a block diagram illustrating FMCW lidar system 750 for autonomous driving according to one embodiment. Lidar (light detection and ranging) uses a light beam to detect objects in the environment. Reflections of the light beam can be used to determine the distance (or range), angular position (or bearing) and velocity of the detected objects. The principle of operation of the FMCW Lidar system 750 can be similar to FMCW Radar system 700 of FIG. 7A.

Referring to FIG. 7B, for example, lidar system 750 can include a chirp laser 751, a beam splitter 753, a two-dimensional (2D) scanner 709, a mixer 763, O/E 511, an analog-to-digital converter 513, and an edge processor (e.g., edge device) 530.

Chirp laser 751 can generate a chirped frequency modulated continuous wave (FMCW) light signal. Beam splitter 753 can split the FMCW light signal into an optical reference signal and an optical transmit signal. 2D scanner 755 can emit the optical transmit signal in a direction and can detect an optical signal (echo) reflected off target object 757. Note that the 2D scanner may be optional if the lidar sensor are spinning or stationary flash sensors. Mixer 763 can mix the detected optical signal and the optical reference signal. O/E 511 can convert the optical signal to an electrical domain. Finally, ADC 513 can digitize the electrical signal and output the signal to edge device 530 for processing. Here, similar to the FMCW Radar signal, FMCW Lidar signal are applied an FFT algorithm to generate a LIDAR data cube. The LIDAR data cube can be used to generate a 4D point cloud (e.g., x, y, z, and velocity) for a target environment of an ADV using one or more FMCW lidar sensors.

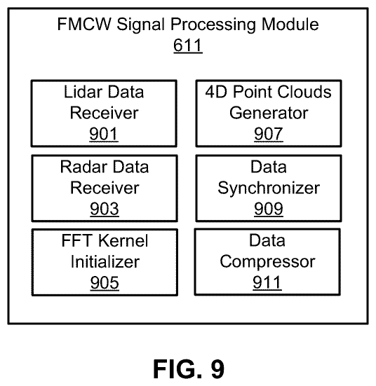

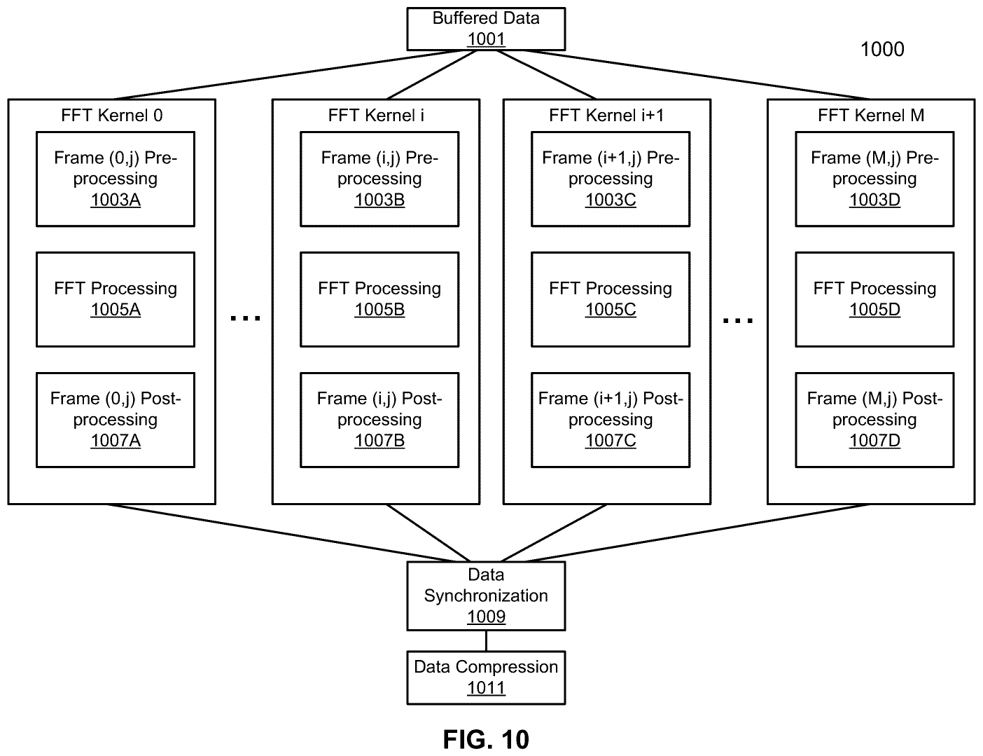

FIG. 9 is a block diagram illustrating a FMCW signal processing module 611 according to one embodiment. FMCW signal processing module 611 can generate a 4D point cloud from lidar or radar data. In one embodiment, FMCW signal processing module 611 can include lidar data receiver 901, radar data receiver 903, FFT kernel initializer 905, 4D point clouds generator 907, data synchronizer 909, and data compressor 911. Lidar data receiver 901 can receive lidar sample data from a lidar frontend. Radar data receiver 903 can receive radar sample data from a radar frontend. FFT kernel initializer 905 can initialize a FFT kernel for a lidar or radar data frame to process the data frame to generate a lidar/radar data cube or portions of a lidar/radar data cube. 4D point clouds generator 907 can generate a lidar/radar 4D point cloud from the lidar/radar data cube. As further described in FIG. 10, radar data and lidar data may be sampled at different frames per second, e.g., 100 versus 10 frames per second. In this case, data synchronizer 909 can upsample or downsample the data to synchronize the lidar with the radar data. Data compressor 911 can compress the 4D point clouds to minimize the bandwidth required to transmit or store the 4D point clouds. Some or all of modules 901-911 may be implemented in software, hardware, or a combination thereof. Some of modules 901-911 may be integrated together as an integrated module.

FIG. 10 is a block diagram illustrating FFT multiprocessing according to one embodiment. FFT multiprocessing 1000 can be performed by edge device 530 of FIG. 6. Referring to FIG. 6, due to the design consideration that FPGA 500 usually has limited on-chip memory, in some embodiment, only a few frames of lidar/radar data are buffered at buffers 506A1-506C3 of FPGA 500. Edge device 530 can fetch the data frames from FPGA 500 to memory 601 of edge device 530 by DMA engine 611, controlled by CPU 603 when data are available. Here, data frames can be stored in memory 601 (as buffered data 1001) of edge device 530 in a buffer ring or any other structures. Once memory 601 accumulates enough data (e.g., at least one channel in the lidar/radar data cube), CPU 603 can execute processing logic (e.g., instructions) for FFT multiprocessing.

Referring to FIG. 10, processing logic can configure one or more FFT kernels (FFT kernels 0, i, i+1 . . . . M), in parallel, to apply FFT processing 1005A-1005D to the data frames of buffered data 1001. Here, the FFT kernels can run in parallel assuming that there are no data dependency between the different data frames. In one embodiment, the kernels can apply pre-processing 1003A-D, such as data formatting, denoising, filtering, etc., to the lidar/radar data frames so the input data follows a required FFT input format. In one embodiment, the kernels can apply post-processing 1007A-D, such as applying a constant false alarm rate (CFAR) or similar algorithms to choose the main frequency tone(s) from the FFT data and to suppress other tones. Here, in some embodiments, the pre- and post-processing can be combined with the FFT processing. Next, the processed data from each kernel are gathered. Due to different sampling rate of the radar and lidar systems, the buffered data may be available at different frames per second, e.g., 100 versus 10 frames per second, respectively. Thus, lidar data can be upsampled, or the radar data can be downsampled for data synchronization 1009 so lidar and radar data have a same frames per second. In one embodiment, processed Lidar data can be duplicated so that there are more lidar frames in comparison with the radar frames for data synchronization. Next, the synchronized data are compressed 1011 using a compression algorithm and the compressed data are sent to host system 110 for perception and planning tasks. Examples of compression algorithm can include Point Cloud Compression, or any other compression techniques.

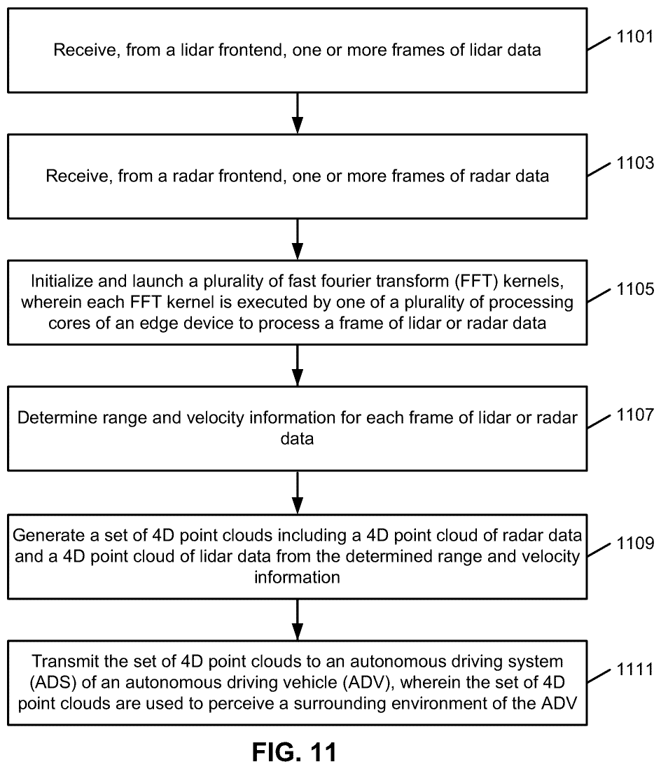

FIG. 11 is a flow diagram illustrating a process to generate 4D point clouds according to one embodiment. Processing 1100 may be performed by processing logic which may include software, hardware, or a combination thereof. For example, process 1100 may be performed by FMCW signal processing module 611 of FIG. 9. Referring to FIG. 11, at block 1101, processing logic receives, from a lidar frontend, one or more frames of lidar data. A frame of lidar data can be a single channel of data in a lidar data cube as shown in FIG. 8B. At block 1103, processing logic receives, from a radar frontend, one or more frames of radar data. A frame of radar data can be a single channel of data in a radar data cube as shown in FIG. 8B. In some embodiments, the radar/lidar data cube has N=1, 2, 3, 4, or any other number of chirps per frame.

At block 1105, processing logic initializes and launches a plurality of fast fourier transform (FFT) kernels, where each FFT kernel is executed by one of a plurality of processing cores of an edge device to process a frame of lidar or radar data.

At block 1107, processing logic determines range and velocity information for each frame of lidar or radar data. For example, the range information can be determined from applying a 2D FFT to the data frame to generate an array of bins. From the bins, a frequency tone with a highest amplitude can represent the difference in frequency between the incident and reflected signals and distance R can be calculated from equation:

$$R = \frac{c \vert Δ t \vert}{2} = \frac{c \vert Δ f \vert}{2 ( \frac{df}{dt} )} .$$

The velocity information can be calculated by applying a doppler-FFT algorithm to the bins. For example, the change in phases among the chirps can be used and velocity can be calculated from equation:

$$v = \frac{λω}{4 π {T}_{c}}$$

where v is velocity, λ is the wavelength, T_{c} is the chirp period, and ω is the angular velocity. Here, if the reflecting object is moving away from the radar sensor, then the frequency of the reflected signal is reduced.

At block 1109, processing logic generates a set of 4D point clouds including a 4D point cloud of radar data and a 4D point cloud of lidar data from the determined range and velocity information. For example, lidar data from lidar frontends can be used to generate a 4D point cloud corresponding of lidar data and radar data from radar frontends can be used to generate a 4D point cloud corresponding of radar data. 4D point cloud includes a 3D point cloud with an additional dimension of velocity embedded in the 3D points.

At block 1111, processing logic transmits the set of 4D point clouds to an autonomous driving system (ADS) of an autonomous driving vehicle (ADV), where the set of 4D point clouds are used by a perception module to perceive a surrounding environment of the ADV.

In one embodiment, the set of 4D point clouds are generated by the plurality of fast fourier transform (FFT) kernels corresponding to the radar and lidar data concurrently, where each of the plurality of FFT kernels is used to perform a FFT algorithm to determine a range, a velocity, or a bearing of an obstacle.

In one embodiment, processing logic further synchronizes the radar data to the lidar data by downsampling the radar data or upsampling the lidar data.

In one embodiment, processing logic further merges (e.g., fuses or combines) two or more 4D point clouds having at least a radar component and a lidar component using synchronized lidar and radar data. The fusion of the lidar and radar data can supplement one another when data is sparse or absent from one of the 4D point cloud.

In one embodiment, the lidar frontend includes at least an optical-electrical converter (O/E) and an analog to digital converter (ADC), where the radar frontend includes a filter and an analog to digital converter (ADC).

In one embodiment, the lidar and radar data are received at a plurality of I/O interfaces of a field programmable gate array, serialized, and are sent to the edge device through a high speed serial communication bus interface of the field programmable gate array.

In one embodiment, the lidar and radar data are buffered at a plurality of data buffers corresponding to the plurality of I/O interfaces of the field programmable gate array, where each of the plurality of data buffers stores N samples of data from an analog to digital converter in a first in first out manner, where Nis an integer number greater than 0.

In one embodiment, processing logic transfers the N samples of data from the plurality of data buffers of the field programmable gate array to a plurality of processing cores of the edge device via a DMA engine of the edge device.

In one embodiment, processing logic further compresses a set of 4D point cloud using a compression technique.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A frequency-modulated continuous-wave (FMCW) radar-lidar system for an autonomous driving vehicle (ADV), comprising:
one or more lidar frontends configured to transmit an incident light signal and to receive a reflected light signal to generate one or more frames of lidar data;
one or more radar frontends configured to transmit an incident electromagnetic wave signal and to receive a reflected electromagnetic wave signal to generate one or more frames of radar data;
a plurality of input/output (I/O) interfaces, each corresponding to one of the one or more lidar frontends or one of the one or more radar frontends to receive the radar data or lidar data; and
an edge device coupled to the plurality of input/output (I/O) interfaces to receive the radar data or lidar data for processing to generate a set of four-dimensional (4D) point clouds that are used to perceive a surrounding environment of the ADV.

2. The system of claim 1, wherein the set of 4D point clouds are generated by processing a plurality of fast fourier transform (FFT) kernels corresponding to the radar or lidar data concurrently, wherein each FFT kernel is used to perform a FFT algorithm to determine a range, a velocity, or a bearing of an obstacle.

3. The system of claim 1, wherein the edge device is further configured to synchronize the radar data to the lidar data by downsampling the radar data or upsampling the lidar data.

4. The system of claim 1, wherein the edge device is further configured to generate merged two or more 4D point clouds having at least a radar component and a lidar component using synchronized lidar and radar data.

5. The system of claim 1, wherein a lidar frontend comprises at least an optical-electrical converter (O/E) and an analog to digital converter (ADC), wherein a radar frontend comprises a filter and an analog to digital converter (ADC).

6. The system of claim 1, further comprising a field programmable gate array, wherein the field programmable gate array comprises the plurality of I/O interfaces and a high speed serial communication bus interface, wherein data at the plurality of I/O interfaces are serialized and are sent to the edge device through the high speed serial communication bus interface.

7. The system of claim 6, wherein the field programmable gate array further comprises: a plurality of data buffers corresponding to the plurality of I/O interfaces, wherein each of the plurality of data buffers stores N samples of data from an analog to digital converter in a first in first out manner, wherein N is an integer greater than 1.

8. The system of claim 7, wherein the edge device is further configured to transfer the N samples of data from the plurality of data buffers at the field programmable gate array to the edge device via a DMA engine of the edge device.

9. The system of claim 1, wherein the edge device is further configured to compress the set of 4D point clouds using a compression technique.

10. The system of claim 1, wherein a data format for a 4D point cloud includes a front-end module identifier specifying an identifier of a frontend device, a time stamp, and cloud data specifying velocity, range, and angular bearings of a surrounding of an ADV.

11. A computer-implemented method, comprising:
receiving, from a lidar frontend, one or more frames of lidar data;
receiving, from a radar frontend, one or more frames of radar data;
initializing and launching a plurality of fast fourier transform (FFT) kernels, wherein each FFT kernel is executed by an edge device to process a frame of lidar or radar data;
determining range and velocity information for each frame of lidar or radar data; and
generating a set of four-dimensional (4D) point clouds from the determined range and velocity information, wherein the set of 4D point clouds are used to perceive a surrounding environment of an autonomous driving vehicle (ADV).

12. The method of claim 11, wherein the set of 4D point clouds are generated by the plurality of fast fourier transform (FFT) kernels corresponding to the radar and lidar data concurrently, wherein each of the plurality of FFT kernels is used to perform a FFT algorithm to determine a range, a velocity, or a bearing of an obstacle.

13. The method of claim 11, further comprising synchronizing the radar data to the lidar data by downsampling the radar data or upsampling the lidar data.

14. The method of claim 11, further comprising merging two or more 4D point clouds having at least a radar component and a lidar component using synchronized lidar and radar data.

15. The method of claim 11, wherein the lidar frontend comprises at least an optical-electrical converter (O/E) and an analog to digital converter (ADC), wherein the radar frontend comprises a filter and an analog to digital converter (ADC).

16. The method of claim 11, wherein the lidar and radar data are received at a plurality of I/O interfaces of a field programmable gate array, serialized, and are sent to the edge device through a high speed serial communication bus interface of the field programmable gate array.

17. The method of claim 16, wherein the lidar and radar data are buffered at a plurality of data buffers corresponding to the plurality of I/O interfaces of the field programmable gate array, wherein each of the plurality of data buffers stores N samples of data from an analog to digital converter in a first in first out manner, wherein N is an integer greater than 1.

18. The method of claim 17, further comprising transferring the N samples of data from the plurality of data buffers of the field programmable gate array to a plurality of processing cores of the edge device via a DMA engine of the edge device.

19. The method of claim 11, further comprising synchronizing the radar data to the lidar data by downsampling the radar data or upsampling the lidar data.

20. An autonomous driving vehicle (ADV), comprising:
an autonomous driving system; and
a frequency-modulated continuous-wave (FMCW) radar-lidar system coupled to the autonomous driving system to provide a set of four-dimensional (4D) point clouds to the autonomous driving system, wherein the FMCW radar-lidar system comprises:
one or more lidar frontends configured to transmit an incident light signal and to receive a reflected light signal to generate one or more frames of lidar data;
one or more radar frontends configured to transmit an incident electromagnetic wave signal and to receive a reflected electromagnetic wave signal to generate one or more frames of radar data;
a plurality of input/output (I/O) interfaces, each corresponding to one of the one or more lidar frontends or one of the one or more radar frontends to receive the radar data or lidar data; and
an edge device coupled to the plurality of input/output interfaces to receive the radar data or lidar data for processing to generate a set of 4D point that are used to perceive a surrounding environment of the ADV.
